(19) United States
(12) Patent Application Publication
(10) Pub. No.: US 2002/0082878 A1
(43) Pub. Date: Jun. 27, 2002

(54) Airline reservation system that supports guaranteed reservations for a preferred category of seating

(76) Inventors: Stephen J. Boies, Mahopac, NY (US); Samuel Dinkin, Austin, TX (US); Paul Andrew Moskowitz, Yorktown Heights, NY (US); Philip Shi-Lung Yu, Chappaqua, NY (US)

Correspondence Address: MORGAN & FINNEGAN, L.L.P., 345 PARK AVENUE, NEW YORK, NY, 10154, US

(21) Appl. No.: 09/747,815

(22) Filed: Dec. 22, 2000

(51) Int. Cl. G06F 17/60

(52) U.S. Cl. 705/5

(57) ABSTRACT

An airline reservation system that supports guaranteed reservations for a preferred category of seating. The system comprises a method for receiving a request for the preferred category of seating, determining if the preferred category of seating is available, guaranteeing the preferred category of seating, and assigning a passenger to a seat within the guaranteed category of seating. Moreover, the passenger can be reassigned to a different seat within the guaranteed category of seating in order to accommodate an additional seating request. Seating arrangements are finalized at a predetermined time prior to a flight's departure and passengers are permanently assigned to a seat within their preferred category of seating.

### FIELD

A system and method for processing airline reservations for a preferred category of seating and, more particularly, a system which optimizes seating arrangements for guaranteed reservations to accommodate additional seating requests as they are received.

### BACKGROUND

Airlines are continuously trying to provide passengers with enhanced services in order to maintain their current passengers as loyal customers and to attract new business. For example, frequent flier programs have been implemented, additional direct flights have been added and gourmet and specialty menus have been served. However, limited attention has been given to processing reservations for preferred seating on an aircraft, which, for many passengers is a significant aspect of the flight.

Traditionally, passengers were unable to secure seating assignments until check-in. However, advances in technology have allowed passengers and travel agents to communicate directly with an airline's reservation system and procure seat assignments either when the reservation is made or at any point prior to check-in. The majority of airlines allow seat assignments to be secured 30 to 90 days in advance of a flight. When requesting seat assignments, most passengers usually have a preference for a category of seating. (A “category” of seating, as the term is used herein, is the type of seating available on commercial airlines, including, but not limited to window seats, aisle seats, emergency exit row seats, bulkhead seats, and seats near galleys and restrooms.) In existing reservation systems, the passenger can request a particular category of seating or a direct seat assignment at the time of making the reservation, wherein the reserving agent queries the system to determine if the passenger's request can be granted. Most travel agents are able to view a seat map of the flight to determine which seats are available and how best to accommodate a passenger's seating preference. Additionally, when processing a reservation via the internet, passengers can also view seat maps on the web sites of most major airlines to determine if a desired seat is available. If a seat is available in the passenger's preferred seating category, then the passenger is immediately assigned to that seat and the status of that seat is changed from available to unavailable in the seating inventory database and on the seat map. If, however, there is no available seat in the passenger's preferred category of seating, then the passenger is arbitrarily assigned to the next available seat. Therefore, earlier-booking passengers have more seating options to choose from as opposed to later-booking passengers.

However, some airlines still do not allow seat assignments to be procured until check-in begins, usually two to three hours before the flight's departure. Additionally, many passengers choose not to secure seat assignments until check-in, or are unaware of the ability to procure seating prior to check-in. In such situations, passengers securing seat assignments at the earlier part of the check-in process have more seating options available than those passengers checking in at a later stage of the process. Given the existing seating assignment practices used by current reservation systems, passengers who are later-booking travelers and those who are late arrivals at the check-in counter will have a limited selection when choosing seats for a given flight.

An airline's ability to accommodate more of its passengers' requests for a particular category of seating is hampered by the fact that current reservation and check-in systems do not allow the airline to reassign seating to accommodate additional requests. For example, if passenger A prefers a window seat, then passenger A would be content sitting at any window location on the plane and the airline could reassign passenger A to another window location in order to accommodate passenger B's request for a window seat in row five. Existing airline reservation systems currently support only three reservation states: (1) a confirmed reservation with an assigned seat; (2) a confirmed reservation without an assigned seat; and (3) a waiting list. Additionally, the existing reservation systems do not allow assigned seats to be reassigned. Only when a passenger's reservation is cancelled and the seat selection becomes available can a confirmed passenger or a new passenger be assigned to the vacant seat. Thus, passengers can only be confirmed for a specific seat assignment and cannot be reassigned by the airlines in order to accommodate additional requests.

### SUMMARY

The above-identified problems are solved and a technical advance is achieved by an airline reservation system that supports guaranteed reservations for a preferred category of seating. In accordance with one aspect of the reservation system, there is provided a method for processing airline reservations for a preferred category of seating, comprising receiving a request for the preferred category of seating, determining if the preferred category of seating is available, and guaranteeing the preferred category of seating.

In accordance with another aspect of the reservation system, there is provided a method for processing airline reservations for a preferred category of seating, comprising receiving a request for multiple preferred categories of seating, determining which of the multiple preferred categories of seating are available, and guaranteeing at least one of the preferred categories of seating.

A request for a preferred category of seating can be received and processed at the time of making the reservation, prior to check-in, or at the check-in counter. In one embodiment, the request is received and processed by the airline reservation controller to determine whether or not the request can be accommodated given the earlier requests that have already been guaranteed a category of seating. An advantage of the reservation system is that the system can reassign passengers to different seats within their guaranteed category of seating in order to satisfy a subsequent passenger's request. Once the passenger is guaranteed a category of seating, the passenger is assigned to a “flexible” seat assignment. However, the passenger can be reassigned to a different seat within the same category of seating based on another request. Therefore, in the reservation system, the passenger is not confirmed for a direct seat assignment, but, is guaranteed a category of seating.

The flexible seat assignments are then translated to permanent seat assignments at a predefined period prior to the flight's departure. At this transition point, the passenger is permanently assigned to a seat which satisfies his/her request for a preferred category of seating, and the passenger cannot be reassigned to a new seat.

Further features and advantages of an airline reservation system that supports guaranteed reservations for a preferred category of seating will be obtained by reference to the following detailed description and drawings.

While the embodiments of the invention will be described with reference to an airline reservation system that supports guaranteed reservations for a preferred category of seating, the method and apparatus described herein are equally applicable to other types of reservation systems wherein requests for a preferred category of service are made. For example, the reservation system could be utilized for hotel rooms as well as any venue or event having assigned seats within different categories of seating.

### BRIEF DESCRIPTION OF DRAWINGS

FIG. 1 is a block diagram illustrating an airline reservation system that supports guaranteed reservations for a category of seating;

FIG. 2 is a block diagram illustrating an exemplary embodiment of the airline reservation central controller used in the system of FIG. 1;

FIG. 3 illustrates an exemplary flight inventory database stored in the central controller of FIG. 2;

FIG. 4 illustrates an exemplary reservation database stored in the central controller of FIG. 2;

FIG. 5 is a flowchart illustrating an exemplary process of guaranteeing a passenger's request for a preferred category of seating; and

FIG. 6 is an exemplary timeline illustrating when airline seating is finalized.

It will be understood that the foregoing brief description and the following detailed description are exemplary and explanatory of the reservation system, but are not intended to be restrictive thereof or limiting of the advantages which can be achieved by the reservation system.

### DETAILED DESCRIPTION

### Introduction

The method and system of the reservation system satisfies the shortcomings of existing reservation systems by guaranteeing the passengers a category of seating and permitting the airline to reassign passengers in order to accommodate additional seating requests. The seating arrangements are then finalized at a predetermined time prior to the flight's departure and the passengers are permanently assigned to a seat within their preferred seating category.

### System

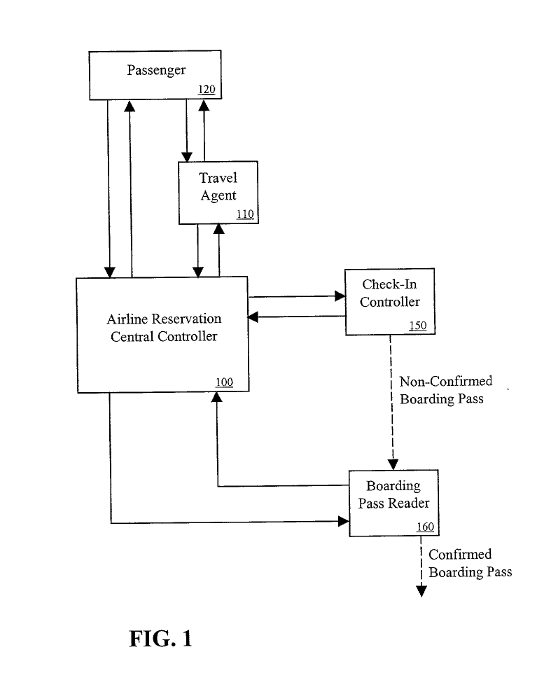

FIG. 1 illustrates the system for receiving requests for a particular category of seating, evaluating the ability to accommodate seating requests and finalizing seating arrangements at a predetermined time prior to a flight's departure.

A “category” of seating, as the term is used herein, is the type of seating available on commercial airlines, including but not limited to window seats, aisle seats, emergency exit row seats, bulkhead seats, and seats near galleys and restrooms. The airline reservation central controller 100 also keeps track of passengers' demographics, such as whether a passenger is an adult, student, child or infant. Therefore, a passenger can request an additional category of seating, such as a seat distant from children and/or infants and also a seat adjacent to other passengers on the flight.

As shown in FIG. 1, the system includes an airline reservation central controller 100, which is configured to receive, store, evaluate and transmit reservation and seating information with a passenger 120, travel agent 110, check-in controller 150 and boarding pass reader 160. The check-in controller 150 and the boarding pass reader 160 are connected to the airline reservation central controller 100 and data is transmitted via a communication port.

The check-in controller 150 is located at the check-in counter and is utilized by a check-in agent to verify the passenger's reservation, process the photo-identification received by the passenger, process the passenger's seating request if the passenger did not previously confirm a seating category, and issue a boarding pass.

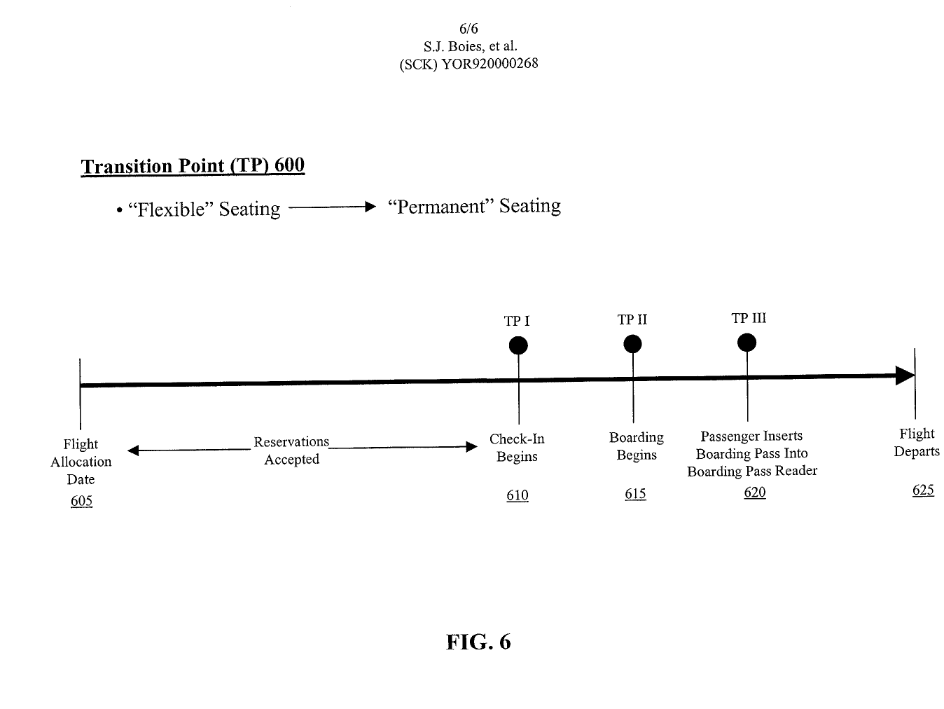

The boarding pass reader 160 is located at the boarding gate and decodes and evaluates the information magnetically encoded on the boarding pass. The passenger or the boarding agent inserts the boarding pass into the boarding pass reader 160, which is connected to the central controller 100. The boarding pass reader 160 can update the information on the boarding pass by printing the updated information directly on the boarding pass or by issuing a new boarding pass. The boarding pass reader 160 and its function in finalizing seating arrangements will be discussed in further detail below in connection with FIG. 6.

In one embodiment, requests for a selected category of seating can be made directly by a passenger 120, indirectly by a travel agent 110, or by another third party such as a consolidator. The requests are received and processed by the airline reservation central controller 100 to determine if such requests can be accommodated.

Requests for a category of seating can be made at the time the reservation is made or at some point prior to boarding. Seating requests are made either directly by the passenger 120 or indirectly by the travel agent 110 by contacting the airline reservation central controller 100 via telephone, facsimile, on-line access, e-mail, or some other communication medium. It is to be noted that each passenger 120 or travel agent 110 may employ a general-purpose computer for communicating with the airline reservation central controller 100. In one embodiment, the general purpose computer of either a passenger 120 or travel agent 110 is comprised of a processing unit, a modem, memory means, and any software required to communicate with the airline reservation central controller 100.

If the passenger 120 chooses not to confirm a category of seating at the time of the reservation or prior to check-in, then the passenger 120 can confirm seating during the check-in process. During check-in, the check-in controller 150 accesses the airline reservation central controller 100 to determine if the passenger's seat request can be accommodated.

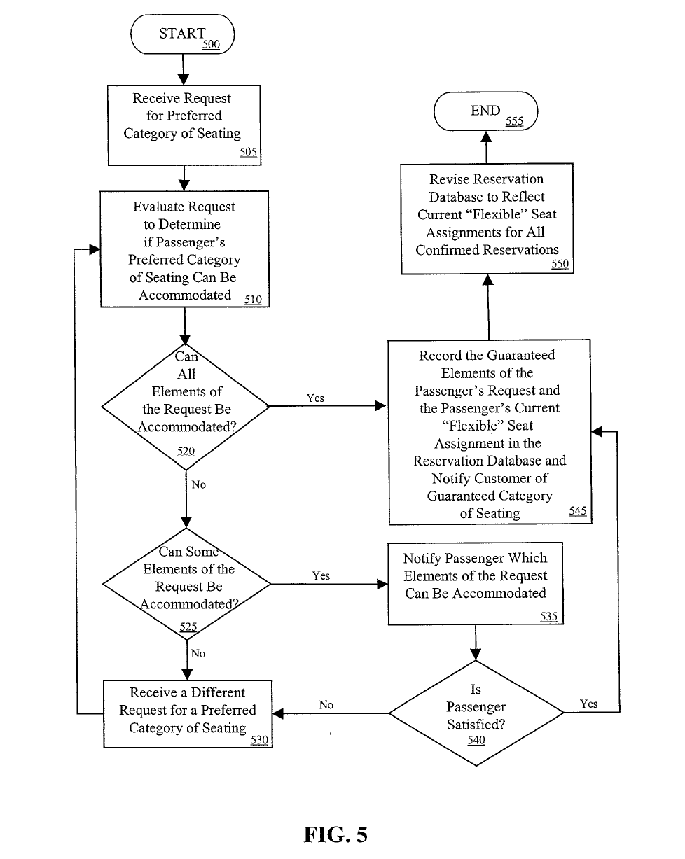

As discussed in further detail below in connection with FIGS. 5 and 6, the central controller 100 determines whether the passenger's request can be accommodated based on earlier passenger requests that have already been guaranteed for a category of seating. As subsequent requests are received, the central controller 100 reassigns passengers to different seats that satisfy their seating requests and satisfy the incoming requests. Therefore, once the passenger is guaranteed a seating category, the passenger is assigned to a “flexible” seat assignment which can be reassigned to accommodate additional requests.

A passenger's request can consist of multiple categories of seating, herein referred to as elements of a request. For example, a passenger may request a window seat in the first 10 rows of coach class. This request consists of two categories of seating, or two elements: element A is a window seat and element B is a seat in the first 10 rows of coach. In one embodiment, an airline may choose to limit the number of elements a passenger can specify within a request, or, the airline may choose to accommodate only a portion of the elements within the request.

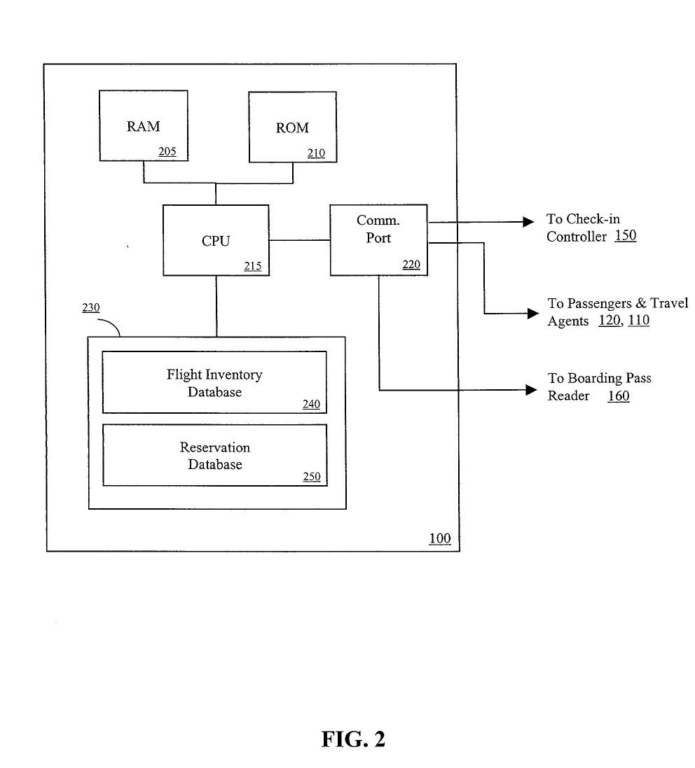

FIG. 2 is a block diagram illustrating the system architecture of an exemplary airline reservation central controller 100. As shown in FIG. 2, the central controller 100 is a conventional general purpose computer, including a central processing unit (“CPU”) 215, read-only memory (“ROM”) 210 and random access memory (“RAM”) 205. The central controller 100 also includes a storage device 230 and a communications port 220. The storage device may include hard disk magnetic or optical storage units, as well as CD-ROM drives or flash memory.

The CPU 215 executes program code stored in one or more of the ROM 210, RAM 205 and/or storage device 230 according to conventional data processing techniques to carry out the functions and acts described in connection with the central controller 100. The CPU 215 preferably comprises at least one high-speed digital data processor adequate to execute program modules for evaluating and optimizing seat assignments. The CPU 215 may be embodied as a single commercially available processor or as a number of processors operating in parallel.

CPU 215 comprises, in one embodiment, a microprocessor such as an Intel® Pentium Processor, which is electronically coupled to each of the central controller's 100 other elements (e.g., RAM, ROM, etc.).

The ROM 210 and/or storage device 230 are operable to store one or more instructions, while the CPU 215 is operable to retrieve, interpret and execute. In one embodiment, the CPU 215 includes a control unit, an arithmetic logic unit (ALU) and a CPU local memory storage device. The control unit is able to retrieve instructions from the data storage device 230 or ROM 210 while the ALU is able to perform operations needed to carry out instructions. The CPU local memory storage device is capable of providing high-speed storage used for storing temporary results and control information.

As shown in FIG. 2, the communication port 220 connects the central controller 100 to the check-in controller 150, the boarding pass reader 160, as well as the passengers 120 and travel agents 110. The communication port 220 includes multiple communication channels for simultaneously establishing a plurality of connections.

### Database Formats

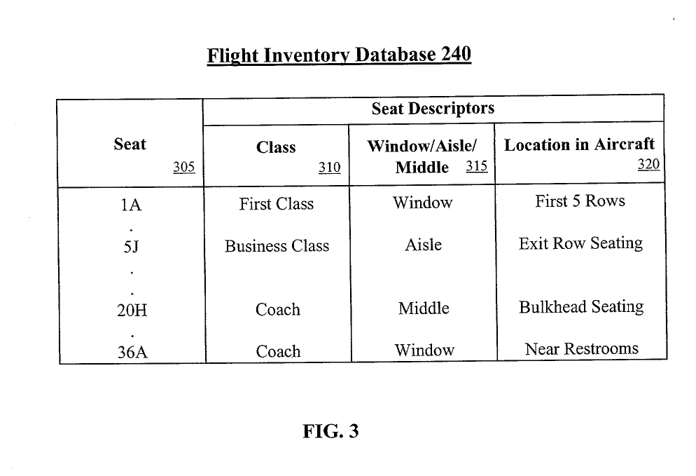

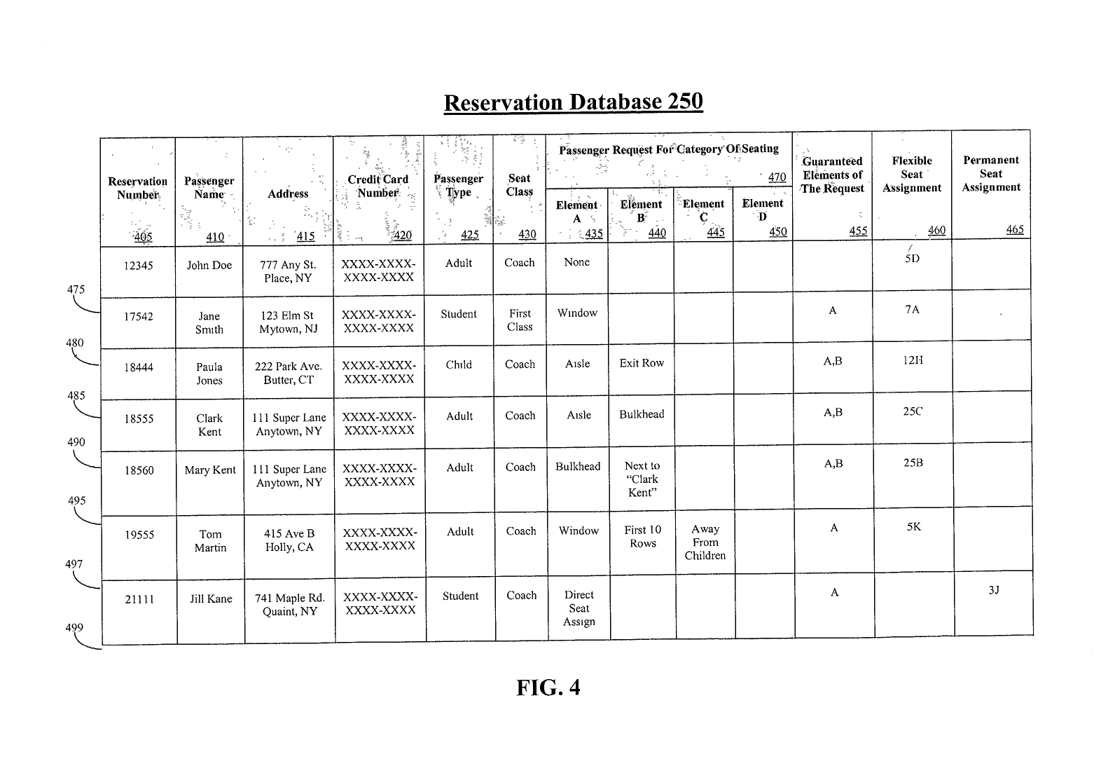

As discussed below in connection with FIGS. 3 and 4, the data storage device 230 includes a flight inventory database 240 and a reservation database 250.

Samples of the contents of databases 240 and 250 are shown in FIGS. 3 and 4. The specific data and fields illustrated in these figures represent only sample records stored in each database. In most cases, the fields shown in FIGS. 3 and 4 are straightforward and self-explanatory. It is to be understood that the data and the fields, as well as the number of databases, can be readily modified from the described embodiment and adapted to provide variations for receiving and processing requests for preferred categories of seating. Furthermore, each field may contain more or less information. For example, the address field may be divided into separate fields containing street address, apartment number, city, state, and zip code. Also, in other embodiments, the databases may be combined or divided into additional databases.

FIG. 3 illustrates an exemplary flight inventory database 240 that stores information for a given flight, on a per seat basis. For each seat, identified by the seat number in field 305, the flight inventory database includes three seat descriptors: the class, position, and location of the seat in the aircraft, illustrated in fields 310, 315, and 320, respectively.

FIG. 4 illustrates an exemplary reservation database 250 that stores information for each reservation, including passenger requests for a preferred category of seating. The reservation database maintains a plurality of records, such as records 475-499, each associated with a different reservation. For each reservation identified by the reservation number in field 405, the reservation database 250 stores personal information, such as the passenger's name, address and credit card number, in fields 410, 415, and 420, respectively. In addition, the reservation database 250 includes the passenger type in field 425; that is, whether the passenger is an adult, student, child or infant. Further, the reservation database 250 stores the class of seating the passenger is confirmed for in field 430, such as coach, business or first class. The reservation database 250 also includes the passenger's request for a selected category of seating, and allows a certain number of elements for each request to be stored. A passenger's request can consist of multiple elements. For example, a passenger can request an aisle seat in an emergency exit row adjacent to a certain passenger. This request has three elements: element A, an aisle seat, element B, a seat in an emergency exit row and element C, a seat adjacent to a certain passenger. The elements of the request are recorded in fields 435, 440, 445 and 450, where the maximum number of fields may be predefined by the airline. The illustrative reservation database 250 shows fields for storing four elements of a request. In one embodiment, an airline may choose to limit the number of elements a passenger can specify within a request. In a further embodiment, the airline may choose to honor only the first two elements or any two specified elements of the request. Once the overall seating evaluation is executed by the central controller 100, the reservation database 250 stores guaranteed elements of the request in field 465. Finally, the “flexible” seat assignment is stored in field 460 of the reservation database 250. If, however, the passenger has requested a direct seat assignment, then that seat number is stored in field 465. As the overall seating evaluation is executed and the passengers are reassigned, the “flexible” seat assignments are continuously updated. At any instant, the reservation database 250 can be accessed to determine what the current seat assignment is for a given passenger. Once the transition point, which is the instant when the “flexible” seat assignments become “permanent”, is defined, the seat number in field 460 will be transferred to and stored in field 465, the field for a “permanent” seat assignment. At this point, the passenger can no longer be reassigned to a different seat.

The illustrative reservation database 250 depicts some of the various types of requests that can be made by each passenger. For example, reservation number 12345, identified by record 475, indicates no preference for a selected category of seating. Therefore, “None” is recorded in the Element A field and the passenger may be assigned to any seat on the aircraft. However, the passenger may subsequently contact the airline prior to check-in or at the check-in counter and request a preferred category of seating. The reservation numbers 17542, 18444, and 18555, which are identified by records 480, 485, and 490, respectively, illustrate common passenger requests for types of seats on an aircraft, such as window, aisle, exit row or bulkhead seats. Additionally, reservation numbers 18560 and 19555, which are identified by records 495 and 497, respectively, illustrate passenger requests for seating associated with other passengers on the aircraft. The passenger may request to be seated adjacent to certain passengers, as illustrated in record 495, Element B, or seated away from a type of passenger such as children, as indicated in record 497, Element C. The final illustrative reservation, identified by record 499, is confirmed for a direct seat assignment. “Direct Seat Assign” is recorded in the Element A field and the seat number is stored in field 465, which is the field reserved for permanent seat assignments.

### Seating Request Process

FIG. 5 illustrates the process of receiving and evaluating a request from a passenger for a preferred seating category. In one embodiment, the seating request process is executed after the passenger has been confirmed for a flight and the passenger information has been entered into the reservation database 250. In another embodiment, the seating request process is executed when a passenger inquires about a flight reservation, because that passenger will only accept a flight which can accommodate his/her preferred seating request(s).

As shown in FIG. 5, the central controller 100 receives a request for a preferred category of seating from either a passenger 120 or a travel agent 110 (on behalf of a passenger 120) in step 505. The request for a preferred seating category can be received and processed by the central controller 100 at three instances: (1) when the reservation is being made; (2) subsequent to the reservation but prior to check in; or (3) at the check-in counter. In one embodiment, if the passenger 120 chooses not to exercise his/her option of requesting a preferred category of seating at the time of confirming the reservation, then the passenger 120 is notified that he/she may contact the airline reservation central controller 100 prior to check-in to request a seating category.

The passenger's request for a preferred seating category is entered into the reservation database 250 during step 505. The request may consist of multiple categories of seating (that is, elements of a request) and, as previously discussed, the elements are recorded in separate fields in the reservation database 250. For example, a passenger 120 can request a window seat in the first 10 rows of coach. This request has two categories of seating or two elements: element A, a window seat, and element B, a seat in the first 10 rows of coach. An additional illustrative request is an aisle seat, in an exit row, adjacent to another passenger on the aircraft. This request has three elements or three categories of seating, element A, an aisle seat, element B, a seat in an exit row, and element C, a seat adjacent to another passenger on the aircraft. Also, a passenger 120 can still request a direct seat assignment instead of a category of seating.

As seating requests are received and processed, the passenger 120 is assigned to a seat assignment which satisfies either all or some elements of the request. However, the passenger 120 can be reassigned to another seat which satisfies his/her guaranteed request in order to accommodate another passenger's request, hence the term “flexible” seat assignment. Therefore, the passenger 120 is not confirmed for a direct seat assignment but, is guaranteed a category of seating.

Once the passenger's request has been received, the central controller 100 evaluates the request to determine whether or not the passenger's request can be accommodated given the earlier requests that have already been guaranteed (step 510). The central controller 100 reassigns passengers to different seats within their guaranteed category of seating in order to satisfy the incoming passenger's request.

Based upon the passenger's request stored in the reservation database 250 and the descriptors associated with each seat in the flight inventory database 240, the central controller 100 evaluates both databases to identify the availability of seats that satisfy the passenger's request. If no seats are originally available, but flexibility is evident, the central controller 100 revises and optimizes the seating assignments by reassigning individuals within their guaranteed seating category in order to satisfy the new request. The central controller 100 queries both the flight inventory database 240 and the reservation database 250 to determine the most optimal seating arrangement to accommodate both the guaranteed reservations and the incoming request. For example, if passenger B requests a window seat in row 15 of coach class, and passenger C, who is confirmed for a window seat only, is currently assigned to one of the window seats in row 15, then passenger C can be reassigned to another window seat in the aircraft in order to accommodate the request from passenger B. Additionally, if passengers D and E request a middle seat and a window seat in the last 5 rows of the aircraft adjacent to each another, and passenger F, who is confirmed for a middle seat only is currently assigned to the only available middle seat with an unoccupied adjacent window seat, then passenger F can be reassigned to another middle seat in the aircraft to accommodate the requests from passengers D and E.

Thereafter, the central controller 100 determines whether or not all elements or seating categories of the request can be accommodated (step 520). If the central controller 100 can accommodate all elements of the passenger's request, then, in step 545, the central controller 100 records the elements of the request that have been accommodated as well as the “flexible” seat assignment in fields 460 and 465 of the reservation database 250, respectively. Additionally, the reservation database 250 is updated to reflect the current “flexible” seat assignments for all confirmed reservations which may have been modified to accommodate the incoming request. If, however, the central controller 100 cannot accommodate all elements of the request, either because the guaranteed seating requests prevent it, or because the airline has chosen to accommodate only a certain number of elements of a request, then the central controller 100 determines if some elements of the request can be satisfied (step 525). If some elements can be satisfied, the passenger 120 is notified of which elements of the request can be accommodated in step 535. If it is determined in step 540 that the passenger 120 is satisfied, then the central controller 100 records the elements of the request that have been accommodated as well as the “flexible” seat assignment in fields 460 and 465 of the reservation database 250, respectively (step 545). Additionally, the reservation database 250 is updated to reflect the current “flexible” seat assignments for all confirmed reservations which may have been modified to accommodate the incoming request (step 550). If, however, the passenger 120 is not satisfied with the elements of the request that can be accommodated, then the central controller 100 can accept a different request for a preferred category of seating from the passenger in step 530. Similarly, if the central controller 100 cannot accommodate any elements of the passenger's request, the central controller 100 can accept a different request for a preferred category of seating from the passenger 120 in step 530. The central controller 100 then returns to step 510 to evaluate whether or not the passenger's new request can be accommodated and the process continues in the manner described above. In confirming the passenger's request, the central controller 100 guarantees that the passenger will be seated in his/her preferred category of seating. The central controller 100 does not issue a seat assignment at this time, but notifies the passenger that he/she is guaranteed to receive the elements of the request that were requested. For example, if a passenger 120 is confirmed for a window seat in an exit row, then that passenger is guaranteed that he/she will be seated in one of the window seats in an exit row.

### Transition Point

In one embodiment, the “flexible” seat assignments are converted to “permanent” seat assignments by the central controller 100 prior to the flight's departure. At this transition point 600, the passenger 120 is permanently assigned to a seat which satisfies his/her request for a preferred category of seating and cannot be reassigned to a new seat. Therefore, the passenger 120 cannot be relocated once the “flexible” seat assignment becomes “permanent”. FIG. 6 is an exemplary timeline illustrating the various instances when the transition point 600 occurs. The transition point 600, which occurs at a predetermined time before the flight's departure, can collectively convert all of the flexible seats to permanent seats or it can convert seating on an individual basis.

In one embodiment, the transition point 600 occurs when check-in begins (610). At this point, all of the “flexible” seat assignments are converted to “permanent” seat assignments and reallocation of permanent seats is prohibited. Passengers who have not requested a category of seating prior to check-in are assigned to seating according to traditional practices, such as scanning the flight inventory to determine the availability of the passenger's request and assigning the passenger to a direct or permanent seat assignment.

In a further embodiment, the “transition” point 600 occurs when boarding begins (615), which is usually 30 to 60 minutes prior to the flight's scheduled departure. Thus, passengers can request a guaranteed category of seating during the check-in process. The check-in controller 150 accesses the airline reservation central controller 100 to determine whether or not the passenger's request can be accommodated in light of previously confirmed requests. If the passenger's request can be accommodated, the check-in controller 150 guarantees the passenger a particular category of seating and issues a non-confirmed boarding pass to the passenger. (A “non-confirmed” boarding pass, as the term is used herein, is a boarding pass which does not have a seat number printed on it.) The non-confirmed boarding pass does, however, contain passenger information both magnetically encoded and visibly readable on the boarding pass. If, however, the central controller 100 accepts a passenger's request for an actual seat assignment during the reservation or the check-in process, then the actual seat number is confirmed and imprinted on the boarding pass. Printing a non-confirmed boarding pass allows the airline reservation central controller 100 to continuously reassign seating to accommodate additional requests throughout the check-in process up to the time of boarding.

The passenger then proceeds to the gate where boarding occurs. At the point when boarding begins the transition point 615 occurs, wherein the flexible seat assignments become permanent. Any passengers who check-in after embarkation has commenced are no longer confirmed for a particular category of seating, and instead are assigned to a specific seat, based on availability and customer preference, as previously discussed.

The permanent seat assignments are printed upon the non-confirmed boarding pass when they are passed through the boarding pass reader 160 located at the embarkation point. The boarding pass reader 160, which is described in detail in U.S. Pat. No. 6,073,836, and incorporated by reference herein, decodes the information on the boarding pass and accesses the airline reservation central controller 100 to evaluate the decoded information and compare it to the information stored in the reservation database 250. The central controller 100 searches for the “permanent” seat assignment associated with the boarding pass of the passenger and prints the seat assignment on the boarding pass. The boarding pass reader 160 then notifies the central controller 100 that the passenger has boarded the aircraft.

In yet another embodiment, the transition from “flexible” to “permanent” seat assignment occurs when the passenger passes his/her boarding pass through the boarding pass reader 160 at the point of embarkation (620). In this embodiment, not every flexible seat assignment is converted in a permanent seat assignment at once. Instead, only the seat assignment of the passenger boarding the aircraft at that moment becomes permanent. The boarding pass reader 160 decodes and evaluates the information on the boarding pass and accesses the airline reservation central controller 100 to convert the flexible seat assignment to a permanent seat assignment and prints the permanent seat assignment on the boarding pass. As passengers board the aircraft and pass their non-confirmed boarding passes through the boarding pass reader 160, their seats become permanent and can no longer be reassigned by the central controller 100. However, the check-in controller 150 can still reassign those passengers who have not yet boarded the aircraft, in order to accommodate a passenger's request received during the check-in process.

In one embodiment, the transition point can be defined by each airline and can be flight specific, allowing for greater flexibility and increased customer service.

While the embodiments of the invention have been described with reference to an airline reservation system that supports guaranteed reservations for a preferred category of seating, the method and apparatus described herein are equally applicable to other types of reservation systems wherein requests for a preferred category of service are made. For example, in one embodiment, the category of service can include assigned seating within different categories of seats or assigned rooms within different categories of rooms. Also, various services that may support guaranteed reservations for a preferred category of service include hotel rooms, seating in stadiums and arenas, seating in concert halls, and seating in a vehicle of transportation.

It is to be understood that the embodiments and variations shown and described herein are merely illustrative of the principles of the present invention. Therefore, various adaptations and modifications may be implemented by those skilled in the art without departing from the spirit and scope of the present invention.

1. A method for processing airline reservations for a preferred category of seating, comprising:
receiving a request for the preferred category of seating;
determining if the preferred category of seating is available;
providing notification that the preferred category of seating is available;
guaranteeing the preferred category of seating;
assigning a passenger to a “flexible” seat assignment within the guaranteed category of seating;
reassigning the passenger to a different “flexible” seat assignment within the guaranteed category of seating based on another request; and
converting the “flexible” seat assignment to a “permanent” seat assignment.

2. A method for processing airline reservations for a preferred category of seating, comprising:
receiving a request for at least one preferred category of seating;
determining if the at least one preferred category of seating is available; and
guaranteeing the at least one preferred category of seating.

3. The method of claim 2, further comprising providing notification that the at least one preferred category of seating is available.

4. The method of claim 2, wherein the request is received from a travel agent.

5. The method of claim 2, wherein the request is received from a passenger.

6. The method of claim 2, further comprising assigning a passenger to a “flexible” seat assignment within the at least one guaranteed category of seating.

7. The method of claim 6, further comprising reassigning the passenger to a different “flexible” seat assignment within the at least one guaranteed category of seating based on another request.

8. The method of claim 2, wherein guaranteeing the at least one preferred category of seating comprises reassigning at least one passenger within the at least one passenger's at least one guaranteed category of seating.

9. The method of claim 2, wherein the request is received when an airline reservation is being made.

10. The method of claim 2, wherein the request is received after an airline reservation is made and prior to a check-in process.

11. The method of claim 2, wherein the request is received during the check-in process.

12. The method of claim 2, wherein the request is received when a passenger inquires about a flight reservation.

13. The method of claim 2, wherein a preferred category of seating is a window seat.

14. The method of claim 2, wherein a preferred category of seating is an aisle seat.

15. The method of claim 2, wherein a preferred category of seating is a bulkhead seat.

16. The method of claim 2, wherein a preferred category of seating is an emergency exit row seat.

17. The method of claim 2, wherein a preferred category of seating is a seat adjacent to a certain passenger.

18. The method of claim 2, wherein a preferred category of seating is a seat away from a type of passenger.

19. The method of claim 2, wherein a preferred category of seating is a seat in a particular section.

20. The method of claim 2, wherein a preferred category of seating is a seat in a particular row.

21. The method of claim 2, further comprising defining a maximum number of preferred categories of seating allowable within the request.

22. The method of claim 6, further comprising:
converting the “flexible” seat assignment to a “permanent” seat assignment; and
prohibiting reallocation of the permanent seat assignment.

23. The method of claim 22, wherein converting the flexible seat assignment to a permanent seat assignment occurs for all passengers simultaneously.

24. The method of claim 23, wherein converting the flexible seat assignment to a permanent seat assignment occurs when check-in begins.

25. The method of claim 23, wherein converting the flexible seat assignment to a permanent seat assignment occurs when boarding initiates.

26. The method of claim 22, wherein converting the flexible seat assignment to a permanent seat assignment occurs as the passenger inserts a boarding pass into a boarding pass reader.

27. A method for processing airline reservations for a preferred category of seating, comprising:
receiving a request for multiple preferred categories of seating;
determining which of the multiple preferred categories of seating are available; and
guaranteeing at least one preferred category of seating.

28. The method of claim 27, further comprising providing notification that at least one of the preferred categories of seating is available.

29. The method of claim 28, further comprising receiving an indication that at least one of the available preferred categories of seating is acceptable.

30. The method of claim 27, further comprising defining a maximum number of preferred categories of seating allowable within the request.

31. The method of claim 27, wherein the request is received from a travel agent.

32. The method of claim 27, wherein the request is received from a passenger.

33. The method of claim 27, further comprising assigning a passenger to a “flexible” seat assignment within the at least one guaranteed category of seating.

34. The method of claim 33, further comprising reassigning the passenger to a different “flexible” seat assignment within the at least one guaranteed category of seating based on another request.

35. The method of claim 27, wherein guaranteeing at least one preferred category of seating comprises reassigning at least one passenger within the at least one passenger's at least one guaranteed category of seating.

36. The method of claim 33, further comprising:
converting the “flexible” seat assignment to a “permanent” seat assignment; and
prohibiting reallocation of the permanent seat assignment.

37. A method for requesting an airline reservation for a preferred category of seating, comprising:
transmitting a request for at least one preferred category of seating; and
receiving notification guaranteeing the at least one preferred category of seating.

38. A system for processing airline reservations for a preferred category of seating, comprising:
means for receiving a request for the preferred category of seating;
means for determining if the preferred category of seating is available;
means for providing notification that the preferred category of seating is available;
means for guaranteeing the preferred category of seating;
means for assigning a passenger to a “flexible” seat assignment within the guaranteed category of seating;
means for reassigning the passenger to a different “flexible” seat assignment within the guaranteed category of seating based on another request; and
means for converting the “flexible” seat assignment to a “permanent” seat assignment.

39. A system for processing airline reservations for a preferred category of seating, comprising:
means for receiving a request for at least one preferred category of seating;
means for determining if the at least one preferred category of seating is available; and
means for guaranteeing the at least one preferred category of seating.

40. The system of claim 39, further comprising means for providing notification that the at least one preferred category of seating is available.

41. The system of claim 39, wherein the request is received from a travel agent.

42. The system of claim 39, wherein the request is received from a passenger.

43. The system of claim 39, further comprising means for assigning the passenger to a “flexible” seat assignment within the at least one guaranteed category of seating.

44. The system of claim 43, further comprising means for reassigning the passenger to a different “flexible” seat assignment within the at least one guaranteed category of seating based on another request.

45. The system of claim 39, wherein means for guaranteeing the at least one preferred category of seating comprises means for reassigning at least one passenger within the at least one passenger's at least one guaranteed category of seating.

46. The system of claim 39, wherein the request is received when an airline reservation is being made.

47. The system of claim 39, wherein the request is received after an airline reservation is made and prior to a check-in process.

48. The system of claim 39, wherein the request is received during the check-in process.

49. The system of claim 39, wherein the request is received when inquiring about a flight reservation.

50. The system of claim 39, further comprising means for defining a maximum number of preferred categories of seating allowable within the request.

51. The system of claim 43, further comprising:
means for converting the “flexible” seat assignment to a “permanent” seat assignment; and
means for prohibiting reallocation of the permanent seat assignment.

52. The system of claim 51, wherein means for converting the flexible seat assignment to a permanent seat assignment occurs for all passengers simultaneously.

53. The system of claim 51, wherein means for converting the flexible seat assignment to a permanent seat assignment occurs when check-in begins.

54. The system of claim 51, wherein means for converting the flexible seat assignment to a permanent seat assignment occurs when boarding initiates.

55. The system of claim 51, wherein means for converting the flexible seat assignment to a permanent seat assignment occurs as the passenger inserts a boarding pass into a boarding pass reader.

56. A system for processing airline reservations for a preferred category of seating, comprising:
means for receiving a request for multiple preferred categories of seating;
means for determining which of the multiple preferred categories of seating are available; and
means for guaranteeing at least one preferred category of seating.

57. The system of claim 56, further comprising means for providing notification that at least one of the preferred categories of seating is available.

58. The system of claim 57, further comprising means for receiving an indication that at least one of the available preferred categories of seating is acceptable.

59. The system of claim 56, further comprising means for defining a maximum number of preferred categories of seating allowable within the request.

60. The system of claim 56, further comprising means for assigning a passenger to a “flexible” seat assignment within the at least one guaranteed category of seating.

61. The system of claim 60, further comprising means for reassigning the passenger to a different “flexible” seat assignment within the at least one guaranteed category of seating based on another request.

62. The system of claim 56, wherein means for guaranteeing at least one preferred category of seating comprises means for reassigning at least one passenger within the at least one passenger's at least one guaranteed category of seating.

63. The system of claim 60, further comprising:
means for converting the “flexible” seat assignment to a “permanent” seat assignment; and
means for prohibiting reallocation of the permanent seat assignment.

64. A system for requesting an airline reservation for a preferred category of seating, comprising:
means for transmitting a request for at least one preferred category of seating; and
means for receiving notification guaranteeing the at least one preferred category of seating.

65. A system for processing airline reservations for a preferred category of seating, the system comprising:
a storage device storing a program;
a processor in communication with the storage device, the processor operative with the program to:
receive a request for the preferred category of seating;
determine if the preferred category of seating is available;
provide notification that the preferred category of seating is available;
guarantee the preferred category of seating;
assign a passenger to a “flexible” seat assignment within the guaranteed category of seating;
reassign the passenger to a different “flexible” seat assignment within the guaranteed category of seating based on another request; and
convert the “flexible” seat assignment to a “permanent” seat assignment.

66. A system for processing airline reservations for a preferred category of seating, the system comprising:
a storage device storing a program;
a processor in communication with the storage device, the processor operative with the program to:
receive a request for at least one preferred category of seating;
determine if the at least one preferred category of seating is available;
guarantee the at least one preferred category of seating.

67. A system for processing airline reservations for a preferred category of seating, the system comprising:
a storage device storing a program;
a processor in communication with the storage device, the processor operative with the program to:
receive a request for multiple preferred categories of seating;
determine which of the multiple preferred categories of seating are available; and
guarantee at least one preferred category of seating.

68. A system for processing airline reservations for a preferred category of seating, the system comprising:
a storage device storing a program;
a processor in communication with the storage device, the processor operative with the program to:
transmit a request for at least one preferred category of seating; and
receive notification guaranteeing the at least one preferred category of seating.

69. An article of manufacture for causing a computer to process airline reservations for a preferred category of seating, comprising:
means for causing the computer to receive a request for the preferred category of seating;
means for causing the computer to determine if the preferred category of seating is available;
means for causing the computer to provide notification that the preferred category of seating is available;
means for causing the computer to guarantee the preferred category of seating;
means for causing the computer to assign a passenger to a “flexible” seat assignment within the guaranteed category of seating;
means for causing the computer to reassign the passenger to a different “flexible” seat assignment within the guaranteed category of seating based on another request; and
means for causing the computer to convert the “flexible” seat assignment to a “permanent” seat assignment.

70. An article of manufacture for causing a computer to process airline reservations for a preferred category of seating, comprising:
means for causing the computer to receive a request for at least one preferred category of seating;
means for causing the computer to determine if the at least one preferred category of seating is available;
means for causing the computer to guarantee the at least one preferred category of seating.

71. An article of manufacture for causing a computer to process airline reservations for a preferred category of seating, comprising:
means for causing the computer to receive a request for multiple preferred categories of seating;
means for causing the computer to determine which of the multiple preferred categories of seating are available; and
means for causing the computer to guarantee at least one preferred category of seating.

72. A method for processing reservations for a preferred category of service, comprising:
receiving a request for the preferred category of service;
determining if the preferred category of service is available;
guaranteeing the preferred category of service;
assigning an individual to a “flexible” assignment within the guaranteed category of service;
converting the “flexible” assignment to a “permanent” assignment; and
prohibiting the reallocation of the permanent assignment.

73. The method of claim 72, further comprising providing notification that the preferred category of service is available.

74. The method of claim 72, further comprising reassigning the individual to a different “flexible” assignment within the guaranteed category of service based on another request.

75. The method of claim 72, wherein converting the flexible assignment to a permanent assignment occurs for all individuals simultaneously.

76. The method of claim 72, further comprising defining a time when the flexible assignment is converted to a permanent assignment.

77. The method of claim 72, wherein the preferred category of service is for seating.

78. The method of claim 72, wherein the preferred category of service is for a hotel.

79. The method of claim 77, wherein the seating is for a vehicle of transportation.

80. The method of claim 77, wherein the seating is for a stadium.

81. The method of claim 77 wherein the seating is for a theatre.

82. The method of claim 77 wherein the seating is for an arena.

83. A method wherein reservations for a preferred category of service are finalized based on a transition point, the method comprising:
assigning an individual to a “flexible” assignment within the preferred category of service; and
converting the flexible assignment to a permanent assignment at the transition point.

84. The method of claim 83, further comprising prohibiting the reallocation of the permanent assignment.

85. The method of claim 83, wherein the transition point is collective and the conversion from a flexible assignment to a permanent assignment occurs for all individuals simultaneously.

86. The method of claim 83, further comprising defining a time when the flexible assignment is converted to a permanent assignment.

87. The method of claim 83, wherein the preferred category of service is for seating.

88. The method of claim 83, wherein the preferred category of service is for a hotel.

89. The method of claim 87, wherein the seating is for a vehicle of transportation.

90. The method of claim 87, wherein the seating is for a stadium.

91. The method of claim 87, wherein the seating is for a theatre.

92. The method of claim 87, wherein the seating is for an arena.
